(19) United States
(12) Patent Application Publication
(10) Pub. No.: US 2008/0020135 A1
(43) Pub. Date: Jan. 24, 2008

(54) Station For Applying Paint Or Powder To Car Bodies

(76) Inventor: Michel Fouvet, Champagnier (FR)

Correspondence Address: CANTOR COLBURN, LLP, 55 GRIFFIN ROAD SOUTH, BLOOMFIELD, CT, 06002, US

(21) Appl. No.: 10/587,000

(22) PCT Filed: Jan. 18, 2005
(86) PCT No.: PCT/FR05/00106

§ 371 Date: May 22, 2007

(30) Foreign Application Priority Data
Jan. 20, 2004 (FR) 0400487

(51) Int. Cl. B05D 1/02; B05B 7/00; B05D 1/12; B05D 7/22; B05B 7/14

(52) U.S. Cl. 427/181; 118/308

(57) ABSTRACT

The invention relates to a station (15) for applying paint or powder to scar bodies, said station comprising at least one body transporting device (2) enabling each body (2) to be displaced in the station according to a transport direction (A), without stopping in the area of the station through which they are passing, and at least one spray robot (16) comprising at least one sprayer (25) and provided with first monitoring means. The invention is characterised in that the station (15) comprises at least one opening device or operating sash (28, 29, 30), each fitted with second monitoring means (32, 33, 35, 40, 42, 45) enabling it to be displaced parallel to the transport direction (A), said second monitoring means being separate from the first means for monitoring the spray robots (16).

The present invention relates to an application station intended in particular for the painting or the spraying of car bodies as well as to a painting or spraying process.

To paint motor vehicle bodies, a coating product is projected in liquid or spray form onto this body. To avoid coating product being projected outside of the painting area, the body is brought by means of a transporting device into a tunnel-shaped station equipped with an airlock and ventilated from top to bottom.

Inside this station are sprayers which project a coating product, in particular paint, onto the body to be painted. These sprayers are mounted on so-called multiaxis robot arms which will be dubbed hereinafter spraying robots.

The station is generally split into areas according to the parts to be painted of the body. Thus the station comprises an area for painting the exterior part of the body and another area for painting certain interior parts of the body. Each of these areas is equipped with robots disposed on either side of the body.

The invention relates in particular to the type of station comprising a transporting device operated according to a so-called continuous or scrolling mode in which the bodies do not stop in the area that they pass through but are displaced at a regular speed in general constant lying between 3 and 8 m/min.

In the area for painting the interior parts of the body, the following interior parts must be painted:
the interior parts of the doors, that is to say the interior part of the door visible once the door has been equipped with trim,
the surround of the doors, that is to say the lateral parts of the doors,
the surround of the door openings in the body,
the underneath of the engine hood,
the interior part of the engine block,
the underneath of the trunk lid.

In the case of the scrolling mode of transport of bodies, in general six multiaxis robots are necessary for carrying out the painting operations: four of these robots for each of the doors, one robot for the hood and the engine block, one robot for the trunk. The bodies always being in motion in the station, it is necessary for the robots to be displaced according to a motion which tracks the displacement of the body so as to be able to paint at constant distance the parts of the body that are situated transversely to the axis of the transporter and reach certain points which would be accessible for too short a time to a fixed robot. These robots are therefore mounted on a so-called tracking mechanism allowing them a translation according to an axis parallel to the axis of the transporter.

Moreover, to paint the interior parts of the body, it is necessary for the doors, the hood and the trunk to be opened. Now, to paint the exteriors of the body, the doors, the hood and the trunk must be closed.

Consequently it is known to equip each robot with an opening device called an “opener” so as to open, keep open throughout the phase of painting and close a door, the hood and the trunk. The tracking mechanism possibly being several meters long, it is known to mount the robot painting the trunk equipped with an opener on the same tracking mechanism as the robot painting one of the rear doors equipped likewise with an opener. Likewise for the hood and one of the front doors.

Thus the station area intended for the painting of the interiors of bodies is composed of two half areas:
the first comprising on one side a robot and its opener mounted on a tracking mechanism for the painting of a rear door and on the other side two robots and their opener mounted on the same tracking mechanism for the painting of the trunk and of the second rear door,
the second comprising on one side a robot and its opener mounted on a tracking mechanism for the painting of a front door and on the other side two robots and their opener mounted on the same tracking mechanism for painting the hood and the engine block and the second front door.

The problems posed by the devices as described hereinabove are multiple.

In the context of a mode of transporting the bodies by scrolling, the painting area for the body interiors is very long since two tracking mechanisms placed end to end are necessary thereby producing a station with a length of the order of 12 to 14 meters.

Given the fact that the robots and the tracking mechanisms are inside the station, it is also very wide.

As indicated hereinabove, several robots may be found on the same tracking mechanism, thereby engendering a constraint during the programming of the movements of each of the robots and a reduction in their flexibility.

A first solution may be afforded by the use of robots as described in French patent application FR 2 804 349 which make it possible to effect a tracking by composition of a movement of rotation of the arm of the robot and of translation along an axis perpendicular to the transporting axis. This solution makes it possible to decrease the clutter due to the robots in the station, since their stand is outside the station.

However, the following problems are not solved by this document.

Equipping a robot with an opener reduces the flexibility of the robot which always has in front of it the mechanism of the opener, this opener causing significant clutter. This constraint therefore imposes either an application time, or a station length, or a robot number that is significant.

Each opener being specific to a type of part of body to be opened, it is necessary to employ a number of robots at least equal to the number of types of parts to be opened.

Moreover, in the case of the use of known tracking mechanisms, the maintenance operations are unwieldy and require the total stoppage of the production line.

Furthermore, the stoppage of the production line is necessary for any maintenance operation on them.

The present invention makes it possible to solve the technical problems cited hereinabove by proposing a solution making it possible to preserve the flexibility of use of the robots, to decrease the number of stoppage of the production line and to decrease the size necessary in the application station by decreasing the number of robot or of opener necessary.

For this purpose, the subject of the present invention is a station for applying paint or powder to car bodies comprising:
at least one device for transporting the bodies making it possible to displace each body through the station according to a direction of transport, the bodies not stopping in the area of the station through which they pass,
at least one spraying robot carrying at least one sprayer and equipped with first means of tracking, characterized in that the station comprises at least one so-called opener opening device for an openable part of the body, each opener being equipped with second means of tracking making it possible to displace it parallel to the direction of transport, according to a motion which tracks the displacement of the body, these second means of tracking being distinct from the first means of tracking of the spraying robots.

This disposition makes it possible to decouple the motion of the robots and of the openers and therefore to use the flexibility of the multiaxis robots. Each opener creates only limited clutter for a robot.

Moreover, a robot no longer being equipped with an opener is no longer specifically assigned to an openable part to be painted.

Moreover, in the case of a discontinuous mode of transport, a mobile opener makes it possible to carry out successively the opening of several parts of the body, thus making it possible to imitate the number of openers.

Advantageously, the application station comprises at least six openers.

This disposition makes it possible to open each openable part of a conventional vehicle body, namely the trunk, the engine hood and the four doors with a different opener, and to thus ensure fast and effective opening.

Advantageously, the first means of tracking of at least one spraying robot are constituted by a composition of motion of rotation of an arm of the robot and of translation along an axis perpendicular to the direction of transport of the base of the arm.

This disposition simplifies the effecting of the tracking of the robots and also of the openers, since the first means of tracking of the robots are not disposed parallel to the axis of transport; it is thus possible to dispose the second means of tracking of the openers parallel to the axis of transport while limiting the clutter constraints induced by the first means on the second means.

According to an embodiment, the base of at least one spraying robot is mounted, in particular in a translationally mobile manner along an axis perpendicular to the direction of transport, on a lateral wall of the station.

This disposition makes it possible to remove from the floor of the station the clutter due to the base of the robots and to thus decrease the clutter constraints occasioned by the openers on the motion of the robots.

Advantageously, the station comprises four spraying robots, two robots being disposed laterally on each side of the direction of transport.

The above dispositions make it possible to effect an arrangement of four robots in the station in the case of a transporter scrolling at high speed, thus decreasing the cost of the installation.

According to an embodiment, at least one opener may be cleared from the station, by a movement of the opener, through an opening made in the internal wall of the station.

This disposition permits the maintenance of the opener from outside without halting the production line while accessing this compartment without entering the interior part of the station, the entry of an operator making it necessary, for safety reasons, to stop the production line.

Advantageously, the second means of tracking of at least one opener comprise a carriage mounted on at least one guide rail disposed parallel to the direction of transport.

According to an embodiment, at least one of the openers comprises an articulated arm comprising two segments lying in one and the same vertical plane and able to pivot with respect to one another.

Advantageously, at least one of the openers comprises an articulated arm comprising two segments translationally mobile with respect to one another and comprising at its end a means of fastening intended to engage with one of the openable parts of the body.

According to an embodiment, at least one of the openers is mounted pivoting about a horizontal axis on second means of tracking situated in a compartment situated underneath the level of the floor of the station.

Advantageously, the station comprises two openers mounted pivoting about a horizontal axis on second means of tracking situated in a compartment situated underneath the level of the floor of the station, these openers making it possible to open and to keep open respectively the trunk lid and the engine hood of the body.

According to an embodiment, at least one of the openers is mounted pivoting about a vertical axis on second means of tracking which are displaced in a lateral compartment separated from the interior of the station by a wall.

Advantageously, the station comprises on each side of the direction of transport at least one opener mounted pivoting about a vertical axis on second means of tracking which are displaced in a lateral compartment separated from the interior of the station by a wall making it possible to open and to keep open respectively a door of the body.

These dispositions permit the maintenance of the opener or of the means of tracking from outside without halting the production line while accessing this compartment without entering the interior part of the station.

According to an embodiment, slots are made in the wall of the lateral compartment so as to allow the passage of the opener.

Advantageously, the lateral compartments receiving the openers are situated underneath the stand of the robots.

The invention also pertains to a process for applying paint or powder to the interior parts of a car body comprising openable parts, the body being displaced along a direction of transport, the body not stopping in the zone of application that it passes through, this process implementing:
at least one means of applying paint equipped with first means of tracking of the displacement of the body, and
at least one means of opening of the openable parts, characterized in that second means of tracking distinct from the first means of tracking displace the means of opening of the openable parts parallel to the direction of transport, according to a motion which tracks the displacement of the body.

Advantageously, at least one means of application is used in the painting of the interior parts corresponding to at least two openable parts.

According to a mode of implementation, the process for applying paint or powder to the interior parts of a car body comprising the following openable parts:
two front doors,
two rear doors,
a trunk lid,
an engine hood,
   is characterized in that it implements:
four means of applying paint, and
six means of opening of the openable parts and in that it comprises successively or simultaneously the steps consisting in:
opening a first rear door with a first means of opening,
opening a second rear door with a second means of opening,
opening a first front door with a third means of opening,
opening a second front door with a fourth means of opening,
opening the trunk lid with a fifth means of opening,
opening the engine hood with a sixth means of opening,
painting with a first means of application the interior parts corresponding to a first rear door and a first portion of the interior parts corresponding to the trunk lid,
painting with a second means of application the interior parts corresponding to a second rear door and a second portion of the interior parts corresponding to the trunk lid complementary to the first portion,
painting with a third means of application the interior parts corresponding to a first front door and a first portion of the interior parts corresponding to the engine hood,
painting with a fourth means of application the interior parts corresponding to a second front door and a second portion of the interior parts corresponding to the engine hood complementary to the first portion.

The invention will be better understood with the aid of the description which follows, with reference to the appended diagrammatic drawing representing a form of execution of this station and illustrating the process.

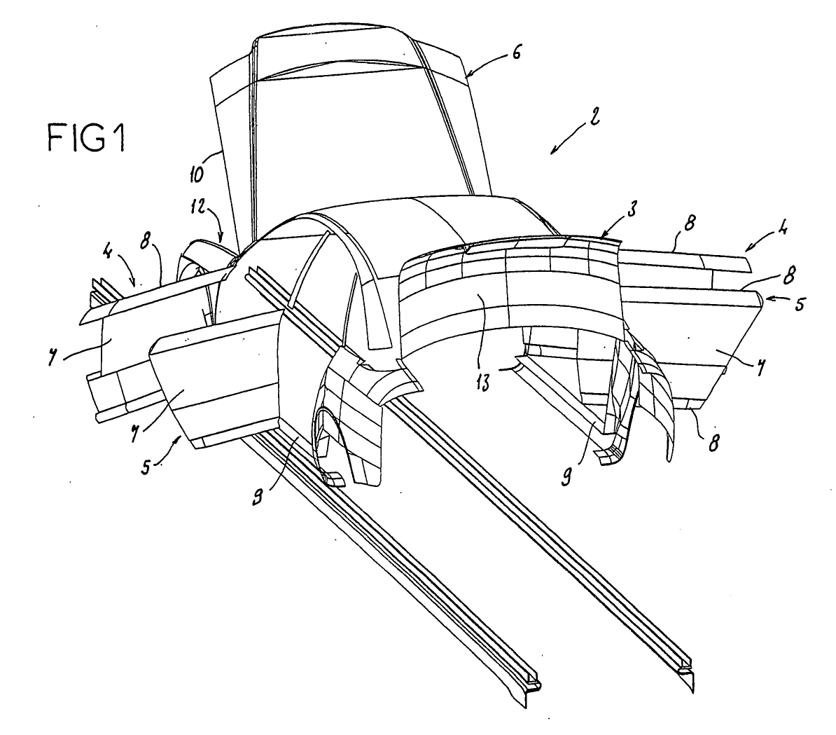

FIG. 1 represents a body intended to be painted.

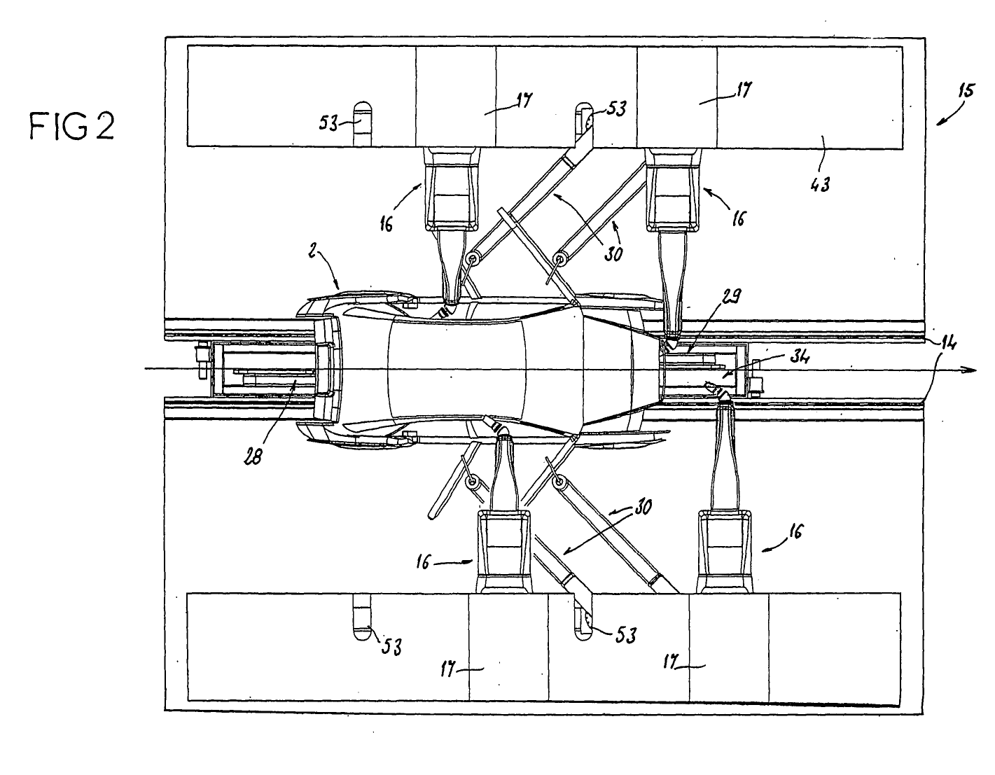

FIG. 2 represents the station, in a partial view from above, the walls of the station having been removed

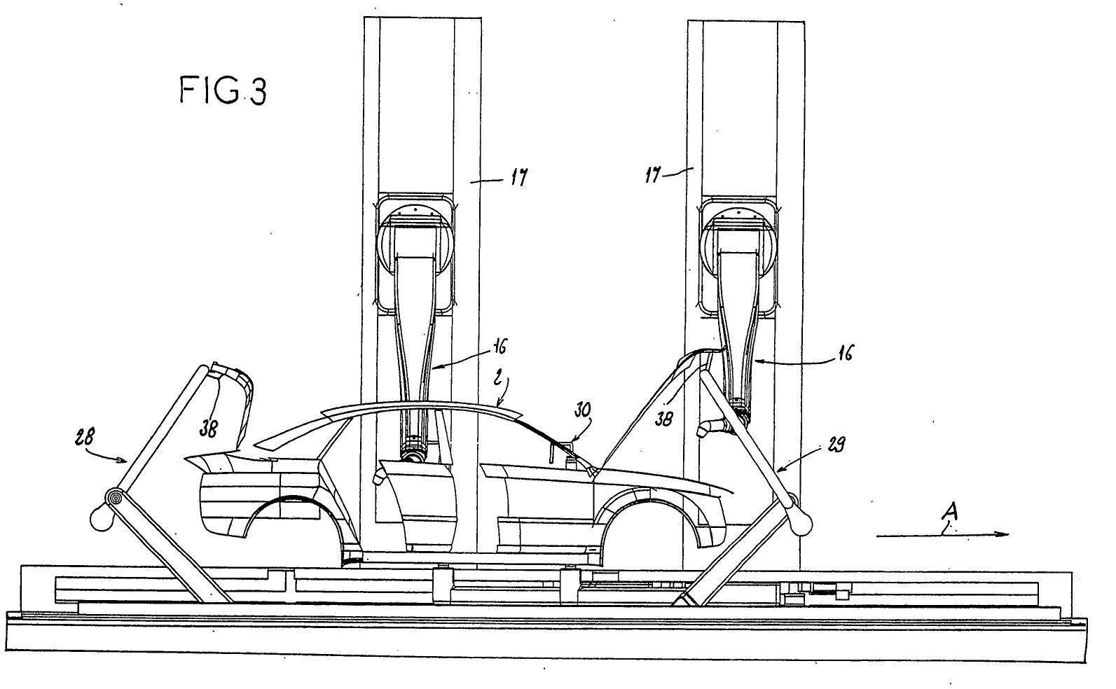

FIG. 3 is a view of the station, in a partial view from above, the walls of the station having been removed

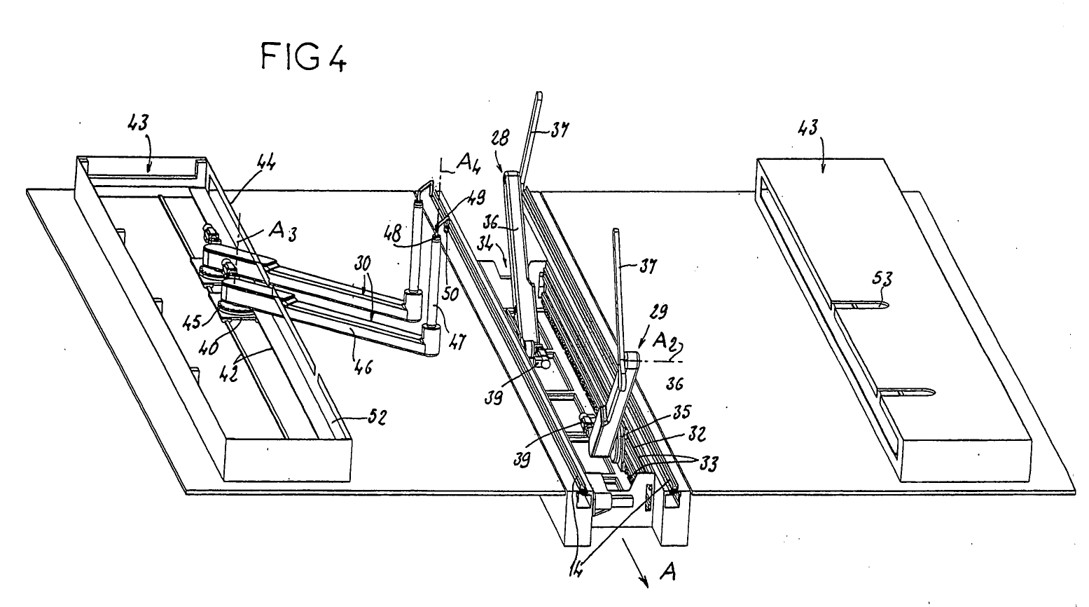

FIG. 4 is a partial view of the station on a magnified scale making it possible to view the openers,

FIG. 5 is a diagrammatic view making it possible to illustrate the manner of operation of a spraying robot.

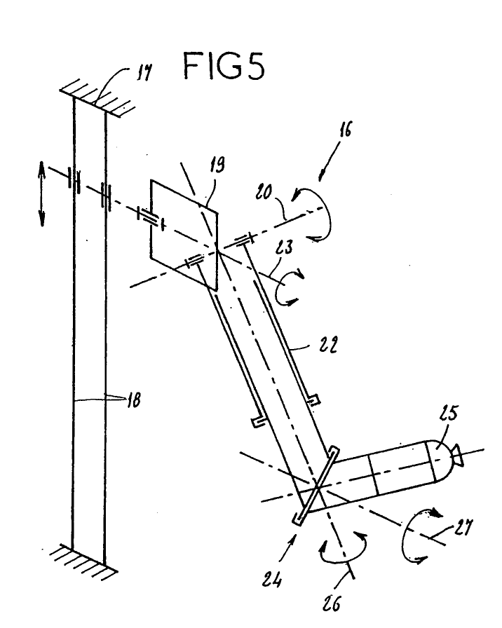

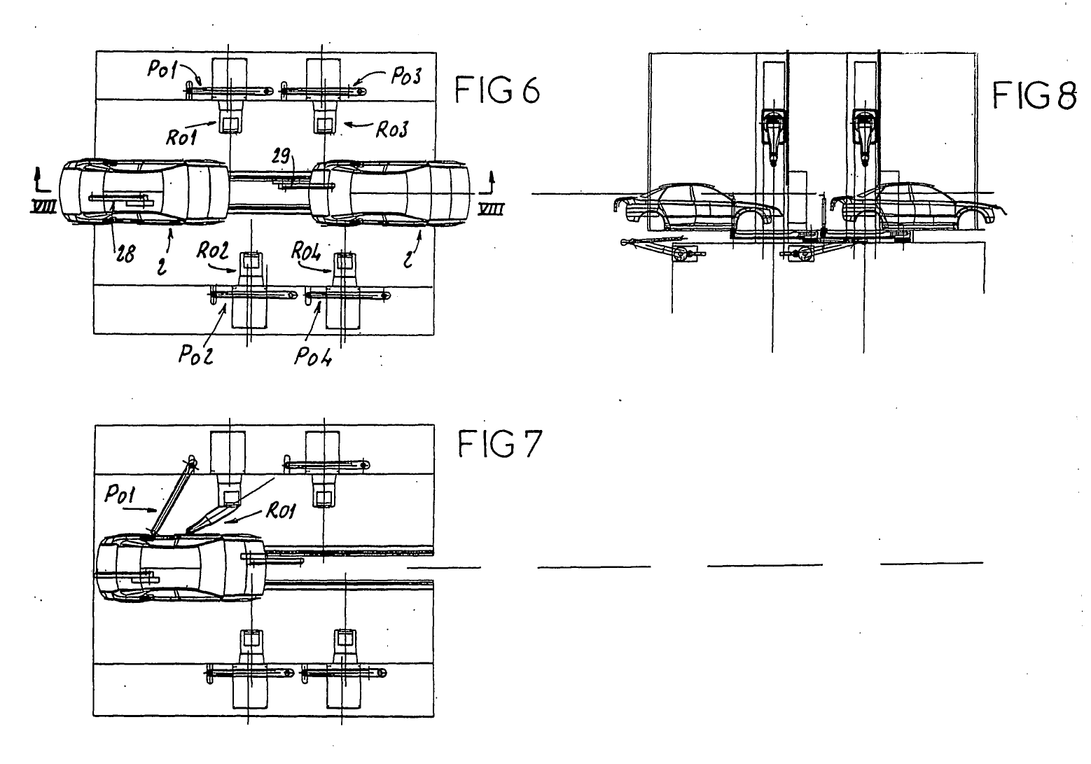

FIGS. 6 and 7 are two views from above on a reduced scale of the station illustrating respectively the start and the end of the first step of the process for painting the body.

FIG. 8 is a side view on a reduced scale along VIII:VIII of FIG. 6.

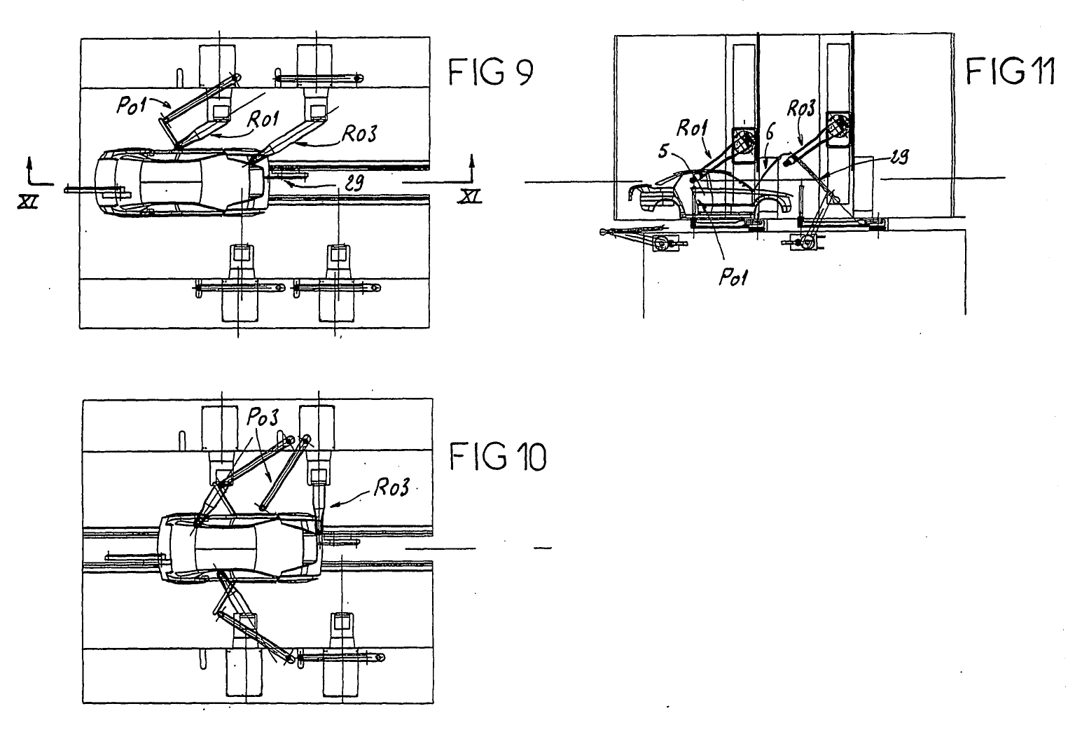

FIGS. 9 and 10 are two views from above on a reduced scale of the station illustrating respectively the start and the end of the second step of the process of painting the body.

FIG. 11 is a side view on a reduced scale along XI:XI of FIG. 9.

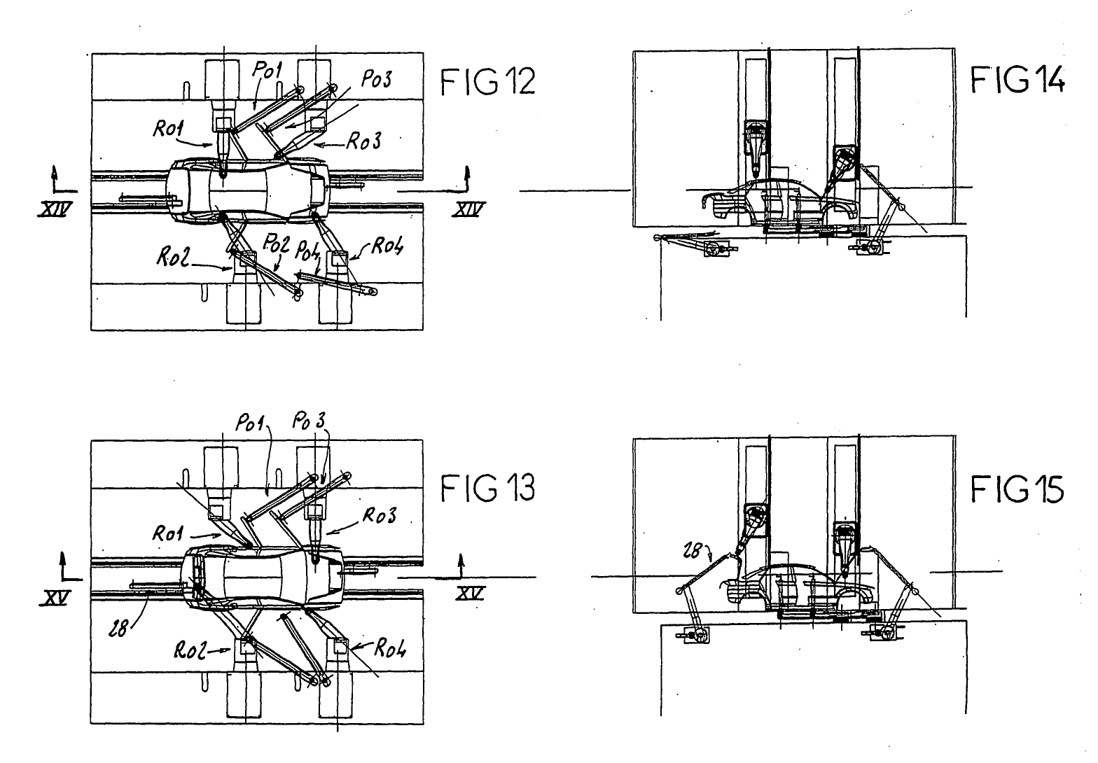

FIGS. 12 and 13 are two views from above on a reduced scale of the station illustrating respectively the start and the end of the third step of the process for painting the body.

FIG. 14 is a side view on a reduced scale along XIV:XIV of FIG. 12, FIG. 15 is a side view on a reduced scale along XV:XV of FIG. 13.

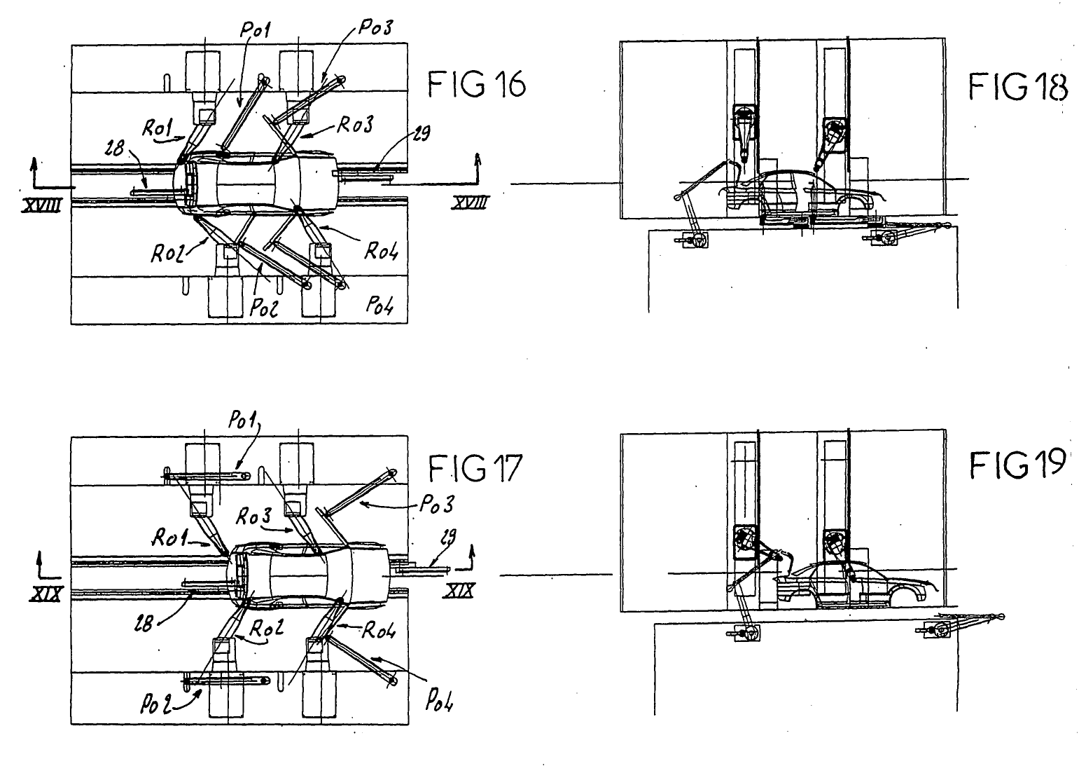

FIGS. 16 and 17 are two views from above on a reduced scale of the station illustrating respectively the start and the end of the fourth step of the process for painting the body.

FIG. 18 is a side view on a reduced scale along XVIII:XVIII of FIG. 16,

FIG. 19 is a side view on a reduced scale along XIX:XIX of FIG. 17.

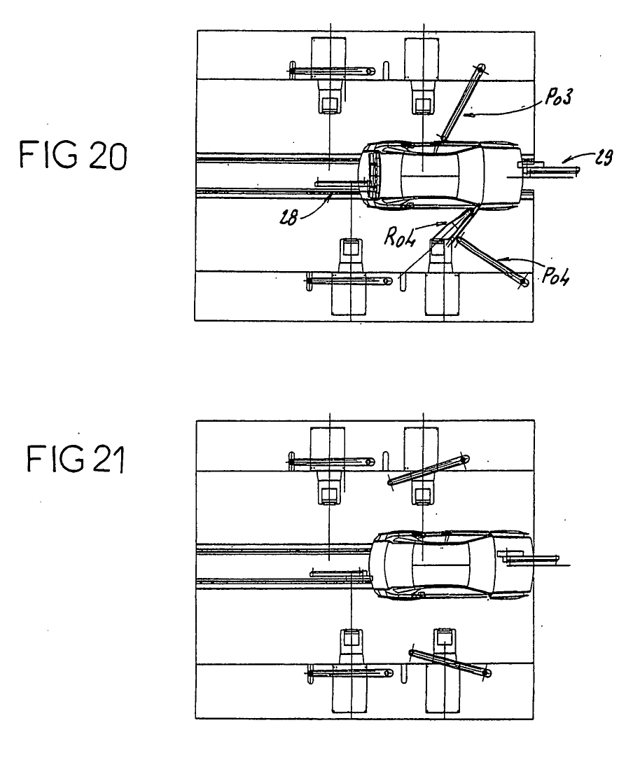

FIGS. 20 and 21 are two views from above on a reduced scale of the station illustrating respectively the start and the end of the fifth step of the process for painting the body.

In FIG. 1, a body 2 is represented, the trunk 3, the front 4 and rear 5 doors, the hood 6 all being open.

The following interior parts of the body 2 have to be painted:
the interior part 7 of the doors 4, 5, that is to say the interior part of the door visible once the door has been equipped with trim,
the surround 8 of the doors 4, 5,
the surround 9 of the door openings in the body,
the underneath 10 of the engine hood 6,
the interior part 12 of the engine block,
the underneath 13 of the trunk lid 3.

The body 2 is displaced during the steps of painting on a transport device (not represented) allowing it to follow guide rails 14 in an application station 15 in the form of a tunnel traversed by the guide rails 14 along a direction of transport A. This station 15 is represented in FIGS. 2 to 4. It is equipped in a known manner with an airlock and ventilated from top to bottom by means that are not represented.

Spraying robots 16, four in number, are disposed on either side of the rails 14. In this embodiment, the robots 16, multiaxis, are of the type described in French patent application FR 2 804 349.

Thus, each robot 16 comprises a machine stand 17 extending substantially vertically and shown diagrammatically in FIG. 5. Vertical guide rails 18 allow the vertical translational displacement of a carriage carrying a base 19. The latter is mounted pivoting about a horizontal axis 20. An arm 22 is mounted pivoting about an axis 23 on the base 19. The axis 23 is perpendicular to the axis 20. The free end of the arm 22 is equipped with a wrist 24 carrying a sprayer 25. The wrist 24 exhibits two degrees of freedom. Firstly, it is mounted pivoting about the longitudinal axis 26 of the arm 20. Next, it possesses a degree of freedom by rotation about an axis 27 inclined by 45° with respect to the axis 26.

In the embodiment of the station represented in FIGS. 2 to 4, two robots 16 are disposed on each side of the guide rails 14. These robots 15 make it possible to ensure a motion of tracking of the body 2, through the composition of the following degrees of freedom:
the arm 22 is mounted pivoting on the base 19, it being possible for the latter to be impelled with a rotational motion about a horizontal axis 20 substantially perpendicular to the axis of transport, and
another degree of freedom is given through a translation along the substantially vertical or horizontal axis 23 of the rotary base 19 carrying the arm 22.

An internal wall of the station, not represented, extends level with the front face, closest to the guide rails 14, of the stands 17, this wall exhibiting openings allowing the passage of the arms of the robots 16.

The station 15 comprises opening devices or “openers” mounted on means of displacement and of tracking making it possible to displace them parallel to the axis of transport:

In particular, the station 15 comprises:
an opener 28 of the engine hood 6,
an opener 29 of the trunk lid 3,
four door openers 30 each corresponding to a front or rear door 4, 5.

Each opener 28 and 29 of the trunk lid 3 and engine hood 6 is mounted on means of displacement and of tracking consisting of a carriage 32 that can be displaced on horizontal guide rails 33 parallel to the direction of transport A. In this embodiment, the horizontal guide rails 33 are two in number and are situated one above the other on the lateral wall of a compartment 34, whose top part is open, situated between the guide rails 14 of the device for transporting the body 2. This compartment 34 is below the guide rails 14.

Each carriage 32 comprises a base 35 fixed with respect to the carriage 32. Each opener 28, 29 consists of an arm articulated in a vertical plane comprising a first segment 36 and a second segment 37 that are such that:
the first segment 36 is mounted pivoting by one of its end about an axis Al on the base 35, the axis A1 being perpendicular to the axis of transport A and horizontal,
the second segment 37 is mounted pivoting about an axis A2 parallel to the axis Al, on the opposite end of the first segment 36 to the end mounted on the base 35.

A foot 38 situated at the opposite end of the second segment 37 to the end mounted pivoting on the first segment 36, is intended to bear on the trunk lid or engine hood so as to open the latter.

The disposition of the openers 28, 29 for the trunk lid 3 and engine hood 6 in the form of arms articulated on the basis of a compartment 34 situated below the rails allows the latter to be folded up into the compartment to allow the passage of the body 2 and of the transport device, then to fold the arm down to open the lids when the body is in position, the carriage 32 being furnished with a servomotor 39 making it possible to displace it and to thus ensure a tracking of the displacement of the body 2.

Each door opener 30 is mounted on means of displacement and of tracking consisting of a carriage 40 that can be displaced on horizontal guide rails 42 parallel to the direction of transport A. In this embodiment, the horizontal guide rails 42 are two in number and are situated in a horizontal plane, substantially at the same height as the guide rails 14 of the device for transporting the body 2.

The horizontal guide rails 42 are fixed in a lateral compartment 43 separated from the interior of the station by a wall 44. Each lateral compartment 43 is situated underneath the stands of the robots 16.

Each carriage 40 comprises a base 45 fixed with respect to the carriage 40. Each door opener 30 consists of an articulated arm comprising:
a first horizontal segment 46 mounted pivoting by one of its ends about an axis A3 on the base 45, the axis A3 being perpendicular to the axis of transport A and vertical, and
a second vertical segment 47 mounted slidably at the opposite end of the first segment 46 to the end mounted on the base 45.

The top end 48 of the second segment 47, opposite the end fixed to the first segment 46, is equipped with a downward curved hook-shaped finger 49 whose end 50 is intended to bear on the interior part of a door 4, 5 so as to open it.

The second segment may be displaced vertically in translation with respect to the first segment 46.

The hook 49 can be displaced in rotation about a vertical axis A4 with respect to the end of the second segment 47.

The wall 44 separating the lateral compartment 43 and the interior part of the station comprises a slot 52 extending horizontally parallel to the direction of transport A allowing the passage of the first segment 46 so that the opener 30 reaches the interior of the cabin.

The compartment 43 also comprises on its upper wall two slots 53 extending horizontally and perpendicularly to the direction of transport A. These slots 53 communicate with the slot 52.

These slots are facing slots made in the internal wall of the station, not represented here so as to allow better visualization of the internal elements.

The disposition of the door openers 30 in the form of arms articulated on the basis of a lateral compartment 42 makes it possible to fold the arm up to open the doors 4, 5 when the body is in position and to keep these doors open.

The opening of a door 4, 5 is effected in the following manner by an opener 30:
the first segment 46 pivots on the base 45 so as to approach in horizontal distance the hook 49 of the door 4, 5, the end 50 of the hook being positioned vertically above the edge of the door by the position of the second segment 47, the hook being oriented in the opposite direction to the door 4, 5,
the second segment 47 having arrived in proximity to the closed door, the hook 49 pivots by 180° so that the end 50 of the hook 49 passes beyond the edge of the door 4, 5 in a horizontal position, the second segment 47 is then displaced by a downward vertical translation, so as to bring the end 50 of the hook 49 below the level of the edge of the door 4, 5,
the first segment 46 pivots on the base 45, so as to move the hook 49 away from the center of the station 15, the end 50 of the hook 49 then bearing on the interior part of the door 4, 5 and opening the latter.

The carriage 42 is furnished with a servomotor 54 making it possible to displace it and to thus ensure a tracking of the displacement of the body 2.

When the application of powder or paint has terminated, the openers 28, 29, 30 accompany the closure of the doors, of the engine hood and trunk lid.

For each door opener 30, a rotation of the first segment 46 on the base 45 so as to bring this first segment vertically in line with the guide rails 42 makes it possible to pass the second segment 47 and the hook 49 to the outside of the internal wall of the station and to house the opener in the slots 53.

This disposition makes it possible, in case of damage to the hook-shaped finger 49, to replace it without intervention inside the station 15, these interventions compelling a stoppage of the production line. This finger is the fragile part of the mechanism and demands regular servicing.

The following FIGS. 6 to 21 make it possible to illustrate the process for applying paint or powder to a body 2 by virtue of the station 15, the body passing through the station without stopping. In order to facilitate the understanding of the various steps, we shall allocate the following reference labels to the spraying robots 16:
R01 for the robot 16 located furthest upstream to the left of the direction of transport A,
R02 for the robot 16 located furthest upstream to the right of the direction of transport A,
R03 for the robot 16 located furthest downstream to the left of the direction of transport A,
R04 for the robot 16 located furthest downstream to the right of the direction of transport A.

Likewise we shall allocate to the four door openers 30 the following labels:
P01 for the door opener 30 located furthest upstream to the left of the direction of transport A,
P02 for the door opener 30 located furthest upstream to the right of the direction of transport A,
P03 for the door opener 30 located furthest downstream to the left of the direction of transport A,
P04 for the door opener 30 located furthest downstream to the right of the direction of transport A.

The process may thus be divided into five main steps E1 to E5 described hereinbelow.

In the initial step El, represented in FIGS. 6 to 8, a body 2 whose interiors have been painted is moved out of the painting area for the interior parts, and a body 2 whose interior parts are to be painted is brought into the painting area for the interior parts by a transporting device using guide rails 14.

At the commencement of this step:
the arms of the robots R01 to R04 are folded up along the wall of the station,
the door openers P01 to P04 are likewise folded up outside the interior part of the station, the first segments 46 being in a lateral compartment 43 and the second segments 47 being housed in the slots 53, each carriage 32 being situated at a distance equal to the length of the first segment downstream of a slot 53
the openers 28, 29 of the trunk lid and engine hood are folded up in the lower compartment 34.

The arm of the robot R01 pivots so as to steer in proximity to a rear door 5, the first segment 46 of the door opener P01 pivots on the base 45 so as to approach proximate to a rear door 5, the corresponding carriage 42 moving to the position of its travel furthest upstream.

The carriage 40 of the engine hood opener 29 moves to the position of its travel furthest upstream so as to be situated underneath the engine hood of the body 2.

In the second step E2, represented in FIGS. 9 to 11, the following operations are carried out.

The opener P01 opens the facing rear door 5, the robot R01 paints the interior parts corresponding to the facing rear door 5, that is to say:
the interior parts 7
the surround 8
the surround 9 in the body 2.

In the same way, on the opposite side, the opener P02 opens the facing rear door 5, the robot R02 paints the interior parts corresponding to the facing rear door 5.

The engine hood opener 29 opens the engine hood 6, the arm of the robot R03 pivots so as to steer in proximity to the engine hood 6, then, for the half of the interior parts located on the side of the said arm, paints the interior parts corresponding to the engine hood, that is to say;
the underneath 10 of the engine hood 6,
the interior part 12 of the engine block.

The first segment 46 of the door opener P03 pivots on the base 45 so as to approach proximate to a facing front door 4, the corresponding carriage 42 moving to the position of its travel furthest upstream.

In the third step E3, represented in FIGS. 12 to 15, the door opener P03 opens the facing front door 4, and the arm of the robot R03 pivots, stopping the painting of the interior parts corresponding to the engine hood, so as to begin to paint the interior parts corresponding to the facing front door 4.

The arm of the robot R04 pivots so as to paint, for the half of the interior parts located on the side of the said arm the interior parts corresponding to the engine hood.

The trunk opener 28 opens the trunk lid 3.

At the end of this step, the arm of the robot R02 ceases to paint the interior parts corresponding to the facing rear door 5 and pivots so as to paint, for the half of the interior parts located on the side of the said arm, the interior parts corresponding to the trunk lid 3, that is to say:
the underneath 13 of the trunk lid 3.

The first segment 46 of the door opener P04 pivots on the base 45 so as to approach proximate to a facing front door 4, the corresponding carriage 42 moving to the position of its travel furthest upstream.

In the fourth step E4, represented in FIGS. 16 to 19, the arm of the robot R01 pivots so as to paint, for the half of the interior parts located on the side of the said arm, the interior parts corresponding to the trunk lid 3.

The engine hood opener 29 recloses the engine hood 6, the door openers P01 and P02 reclose the rear doors 5.

In the fifth step E5, represented in FIGS. 20 to 21, the arms of the robots R1 to R4 fold up once painting has been completed, the door openers P03 and P03 reclose the front doors 4, the trunk lid opener 28 recloses the trunk.

All the openers 28, 29, P01 to P04 return to their initial position.

The invention is not limited to the forms of execution described, it on the contrary encompasses all variants. Thus, in particular, it would be possible to use multi-axis robots of a different known type, in particular of a type described in document U.S. Pat. No. 5,421,218, instead of the robots described.

1. A station for applying paint or powder to car bodies comprising:
at least one device for transporting the bodies making it possible to displace each body through the station according to a direction of transport, the bodies not stopping in an area of the station through which they pass;
at least one spraying robot carrying at least one sprayer and equipped with first means of tracking;
at least one opener opening device for an openable part of the body;
each opener being equipped with second means of tracking making it possible to displace it parallel to the direction of transport, according to a motion which tracks displacement of the body, these second means of tracking being distinct from the first means of tracking of the spraying robots.

2. The application station as claimed in claim 1, further comprising at least six openers.

3. The application station as claimed in claim 1, wherein the first means of tracking of at least one spraying robot comprise a composition of motion of rotation of an arm of the robot and of translation along an axis perpendicular to the direction of transport of the base of the art (22).

4. The application station as claimed in claim 1, wherein the base of at least one spraying robot is mounted, in particular in a translationally mobile manner along an axis perpendicular to the direction of transport on a lateral wall of the station.

5. The application station as claimed in claim 1 further comprising four spraying robots, two robots being disposed laterally on each side of the direction of transport.

6. The application station as claimed in claim 5, wherein at least one opener (28, 29, 30) may be cleared from the station, by a movement of the opener, through an opening made in an internal wall of the station.

7. The application station as claimed in claim 1, wherein the second means of tracking of at least one opener comprise a carriage mounted on at least one guide rail disposed parallel to the direction of transport.

8. The application station as claimed in claim 1, wherein at least one of the openers comprises an articulated arm comprising two segments lying in one and the same vertical plane and able to pivot with respect to one another.

9. The application station as claimed in claim 1, wherein at least one of the openers comprises an articulated arm comprising two segments translationally mobile with respect to one another and comprising at its end a means of fastening intended to engage with one of openable parts.

10. The application station as claimed in claim 1, wherein at least one of the openers is mounted pivoting about a horizontal axis on second means of tracking situated in a compartment situated underneath a level of floor of the station.

11. The application station as claimed in claim 10, further comprising two openers mounted pivoting about a horizontal axis on second means of tracking situated in a compartment situated underneath the level of the floor of the station, these openers making it possible to open and to keep open respectively a trunk lid and an engine hood of the body.

12. The application station as claimed in claim 1, wherein at least one of the openers is mounted pivoting about a vertical axis on second means of tracking which are displaced in a lateral compartment separated from an interior of the station by a wall.

13. The application station as claimed in claim 12, further comprising on each side of the direction of transport at least one opener mounted pivoting about a vertical axis on second means of tracking which are displaced in a lateral compartment separated from the interior of the station by a wall making it possible to open and to keep open respectively a door of the body.

14. The application station as claimed in claim 12, wherein slots are made in the wall of the lateral compartment so as to allow the passage of the opener.

15. The application station as claimed in claim 12, wherein the lateral compartments receiving the openers are situated underneath the stand of the robots.

16. A process for applying paint or powder to interior parts of a car body comprising openable parts, the body being displaced along a direction of transport, the body not stopping in a zone of application that it passes through, the process implementing:
at least one means of applying paint equipped with first means of tracking of the displacement of the body, and
at least one means of opening of openable parts,
wherein second means of tracking distinct from the first means of tracking displace the means of opening of the openable parts parallel to the direction of transport, according to a motion which tracks the displacement of the body.

17. The process for applying paint or powder as claimed in claim 16, wherein at least one means of application is used in painting of the interior parts corresponding to at least two openable parts.

18. The process for applying paint or powder as claimed in claim 17 to the interior parts of a car body comprising the following openable parts:
two front doors,
two rear doors,
a trunk lid,
an engine hood,
wherein the process implements:
four means of applying paint, and
six means of opening of the openable parts and wherein the process comprises successively or simultaneously:
opening a first rear door with a first means of opening,
opening a second rear door with a second means of opening,
opening a first front door with a third means of opening,
opening a second front door with a fourth means of opening,
opening the trunk lid with a fifth means of opening,
opening the engine hood with a sixth means of opening,
painting with a first means of application the interior part corresponding to a first rear door and a first portion of the interior parts corresponding to the trunk lid,
painting with a second means of application the interior parts corresponding to a second rear door and a second portion of the interior parts corresponding to the trunk lid complementary to the first portion,
painting with a third means of application the interior parts corresponding to a first front door and a first portion of the interior parts corresponding to the engine hood,
painting with a fourth means of application the interior parts corresponding to a second front door and a second portion of the interior parts corresponding to the engine hood complementary to the first portion.
